(19) United States
(12) Patent Application Publication
(10) Pub. No.: US 2015/0340068 A1
(43) Pub. Date: Nov. 26, 2015

(54) AUTOMATIC SHOOTING AND EDITING OF A VIDEO

(71) Applicant: BAZELEVS INNOVACII, Moscow (RU)

(72) Inventors: Timur Nuruahitovich Bekmambetov, Moscow (RU); Bogdan Gennad'evich Sevrukov, Kurchatov, Kurskaya obl. (RU)

(21) Appl. No.: 14/007,426

(22) PCT Filed: Feb. 14, 2013
(86) PCT No.: PCT/RU2013/000120

§ 371 Date: Sep. 25, 2013

(51) Int. Cl. G11B 27/034; G11B 27/00; H04N 5/222

(52) U.S. Cl. CPC G11B 27/034; H04N 5/222; G11B 27/002

(57) ABSTRACT

The proposed method relates to a computer technology providing automatic control of a video recording process. The method includes obtaining information regarding an action in the scene and then calculating a film director's description of a shot to be filmed. Thereafter, the shot description is provided to a cameraman and a set of shot variants is generated according to the director's shot description. Camera parameters for shooting each of the shot variants are obtained and the best shot is chosen. The shot is provided back to the film director who finally registers the same in an editorial script. The respective camera is mounted to shoot the best shot. Subsequent shots of the scene actions are obtained by repeating previous method steps and a sequence of shots is generated according to the editorial script. The sequence is then provided to a client computer program.

### CROSS-REFERENCE TO RELATED APPLICATIONS

This application is a U.S. national stage application of an international application PCT/RU2013/000120 filed on 14 Feb. 2013.

### FIELD OF THE INVENTION

The invention relates to computer technology, more particularly to automatically controlling a video shooting process.

### BACKGROUND OF THE INVENTION

At present, techniques are under development for converting a text written in a natural language into images, video, sequence of shots, and the like.

US 2010/0169076 A1, Jan. 7, 2010 discloses a method of converting a set of words into a three-dimensional scene description. This prior art solution comprises performing a linguistic analysis on the text including one or more words, phrases or sentences. Thereafter, a three-dimensional scene description is formed based on the results of semantic analysis. Then, the scene description is interpreted into a three-dimensional scene which is rendered into an image. A user of the system may choose a camera position and viewing perspective, from which to render the three-dimensional scene. Alternatively, heuristics may be added to automate the viewing perspective. However, the prior art solution uses a static camera position and viewing perspective (mainly a long shot). In addition, the resulting three-dimensional scene is not dynamic so that the camera position and viewing perspective remain unchanged in the process of “narration”. Another drawback of the prior art solution is that this method provides no limitations on mounting the camera, i.e., in fact it may be placed too close to an object or even inside an object present in the three-dimensional scene.

At the same time, it is necessary to determine the camera parameters and control the cameras automatically for producing a video since the camera may not obviously stay at the same position all the time in the “narration” process. Furthermore, in order to render the resulting video dynamic and realistic, both long shots and close-ups are to be used and also the camera should turn from one character (object) to another.

Therefore, a need exists in providing a technique for automatically choosing and determining the position, viewing perspective and other camera parameters in the video shooting process. In addition, a need exists in providing a technique for automatically producing a ready to view video by automatically post-producing and editing the images recorded by the cameras.

### SUMMARY OF THE INVENTION

The invention provides the functions of automatic shooting and editing according to the main cinematographic principles.

The above problems are solved by providing a method for automatically controlling a video shooting process. The proposed method includes obtaining information regarding the action in the scene and then calculating a director's description of a shot to be filmed. Thereafter, the shot description is provided to a camera operator and a set of shot variants is generated according to the director's shot description. Camera parameters for shooting each of the set of shot variants are obtained and the best shot is chosen. The shot is provided back to the director who finally registers the same in the editorial script. The respective camera is mounted to shoot the best shot. Subsequent shots of the scene actions are obtained by repeating previous method steps and a sequence of shots is generated according to the editorial script. The sequence of shots is provided to a client program.

In a particular embodiment, the information regarding the scene action is obtained responsive to an action start signal.

In still another particular embodiment, the information regarding the scene action is obtained in the form of a packetized sequence of actions wherein the entire packet is received at a time.

In another embodiment, the director's shot description includes the information regarding the type of action (predicate), protagonist (subject), secondary characters (objects). The already filled in part of the editorial script is also included.

In another embodiment, the editorial script is filled in beforehand for a number of shots in advance when starting a new action.

In still another particular embodiment, the director's shot descriptions are further reconstructed based on the author's shots wherein said author's shots are the shots obtained using the user-preinstalled cameras.

In a specific embodiment, the best shot is considered to be the one closest to the director's shot description while meeting the requirements external with respect to the same. One of such requirements is the visible area percentage of the object being filmed. Another requirement is the observance of the 180-degree rule. Still another requirement is the absence of foreign objects in the focuses of attention of the shot (contrasting objects and/or objects occupying a considerably large area of the shot's central part with respect to the objects being filmed). At the same time, the set of shot variants according to the director's shot description is generated and the best shot is chosen iteratively until the requirements are met.

In a particular embodiment, each shot is provided to the client program immediately upon receipt.

In another embodiment, the sequence of shots is provided to the client program on the client's request.

The invention further provides outputting the shot image to a display.

In a particular embodiment, an array of cameras is set for use as prompts.

In another embodiment, an array of author's cameras is set to supplement the automatically formed ones.

The invention further provides linear editing of a video wherein editing is performed both using a known sequence of the script events and information regarding only the past and current script events.

The invention may be implemented in computer readable medium comprising computer executable instructions which when loaded to a computer cause the computer to perform the steps of a method for automatically controlling a video shooting process.

The proposed invention enables the sets of camera parameters (internal and external) to be automatically obtained for uniquely determining the camera parameters at each given time and said cameras to be automatically mounted in a three-dimensional scene based on the obtained parameters. These parameters define the shooting in an artistically sufficient manner according to the main cinematographic principles. These parameters may be applied both to a virtual camera and a real world camera.

Operating parameters, object actions essential to shooting and information or a source of information regarding the environment (object positions and possibly additional parameters describing the spatial configuration of the world being filmed) are provided to the system input. The system may receive or request some of this data both when started and in operation. The data may describe both the real world and the virtual reality.

The invention further enables:

shots for shooting a particular action to be redefined. Such shot will not be substituted;

an array of cameras to be set for use as prompts for automatic algorithms. This functionality may also be used for simulating the basic elements of the author's style;

an array of author's cameras to be set to supplement the automatically formed ones. The one best fitting for shooting at the moment will be chosen from the aggregate array.

The invention is further operable in one of three modes:

(A) linear editing mode with a known sequence of script events;

(B) linear editing mode using information regarding only the past and current script events;

(C) operation results may be used for nonlinear editing.

In order to solve the above and related problems some illustrative aspects are described herein in connection with the following description and accompanying drawings. However, these aspects present only some possible approaches to applying the principles disclosed herein and are intended to encompass all similar aspects and equivalents thereof. Other advantages and features of novelty will be apparent from the following detailed description with reference to the drawings.

For ease of understanding of the invention, definitions of the mains terms are given below.

A shot means a continuous time interval filmed in a certain way.

An editorial script means a document describing each of the shots and their mutual position. The editorial script may be created at the step describing the director's conception, rough or final editing.

A shot size means an on-screen person's scale.

A perspective (vertical) means a vertical shooting angle. Upper, lower and neutral perspectives are discriminated.

A horizontal perspective means a horizontal shooting angle.

A static shot means shooting with a camera all the time preserving its perspective, position and other parameters.

A dynamic shot means shooting with a moving camera. Typical examples are panoramic shooting, zoom-out, zoom-in, shooting in motion.

A camera means a set of parameters (internal and external) of a model simulating a physical camera. The parameters are position, perspective, zoom.

Linear editing means a real time editing. The image is received simultaneously from a number of cameras. Editing consists in switching the source of image.

Nonlinear editing means editing of the already filmed footage. It enables the sequence of events having been filmed and the course of time to be changed.

Air (vertical) means a margin of free space within the shot over the character's head. It varies depending on the shot size being used and other artistic goals.

Horizontal air means a margin of free space within the shot in front and behind the character. If the character looks at an off-screen object, air is most likely to be present in the character's viewing direction. If the character is lucky to escape, air will be present behind him. If he is caught up, air will be present in front of him.

A director's shot description means a formalized set of parameters:

shot size;

vertical perspective;

horizontal perspective;

horizontal shot composition.

### BRIEF DESCRIPTION OF THE DRAWINGS

FIG. 1 is a general structural diagram of the invention and a method for integrating the same;

FIG. 2 is a structural diagram of the invention showing the sequence of operation steps;

FIG. 3 is a general operation algorithm of the invention;

FIG. 4 is a schematic presentation of an exemplary scene;

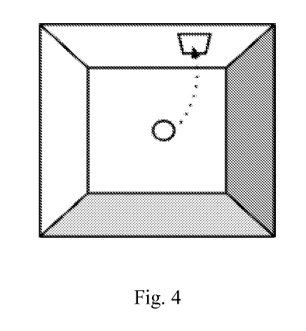

FIG. 5 is an exemplary set of shots obtainable by processing the exemplary actions according to the invention.

### DETAILED DESCRIPTION OF THE INVENTION

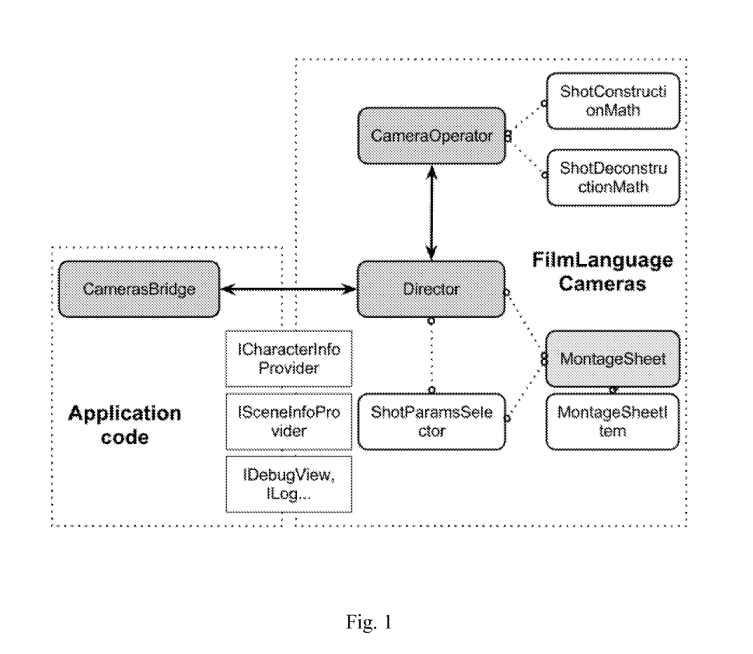

The system may be conceptually divided into three parts (FIG. 1): Integration module, Director module, Camera operator module.

The CamerasBridge integration module provides integration of the proposed solution. It is intended for:

providing input data and operation parameters;

providing implementation of satellite interfaces (ICharacterInfoProvider, ISceneInfoProvider, IDebugView, ILog);

obtaining the resulting sequence of artistically significant shots.

The CamerasBridge module is designed to enable a fast integration of the system into a new environment.

The Director module describes the shot to be filmed at the moment according to internal algorithms and settings. This module makes decisions based on the generally accepted rules of shooting and editing.

The CameraOperator module is adapted to render the shot according to the description received from the director on the one hand and based on physical limitations on the other hand. This module makes decisions according to the generally accepted rules of shooting and based on the information regarding a physical scene (configuration and dimensions of objects, etc.).

Each system module and submodule may be implemented as software, hardware or firmware. The implementation of each module is dependent on the tasks and functions of the system or particular module.

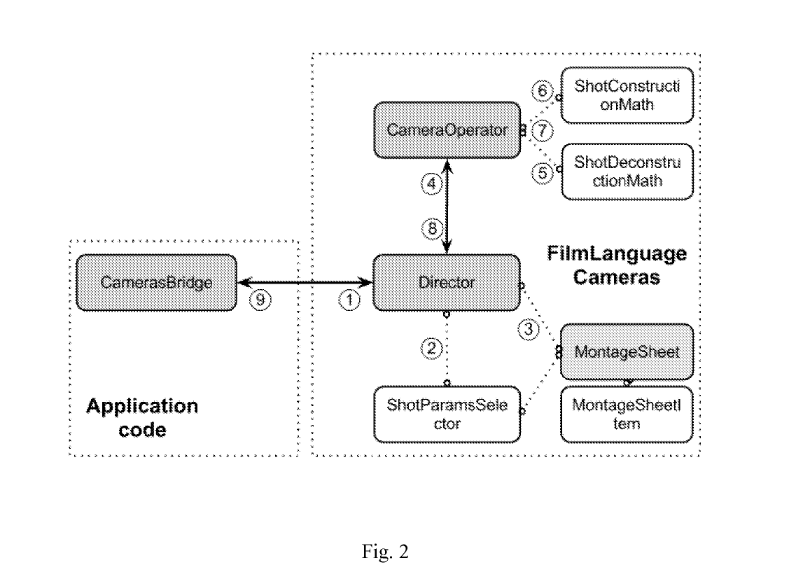

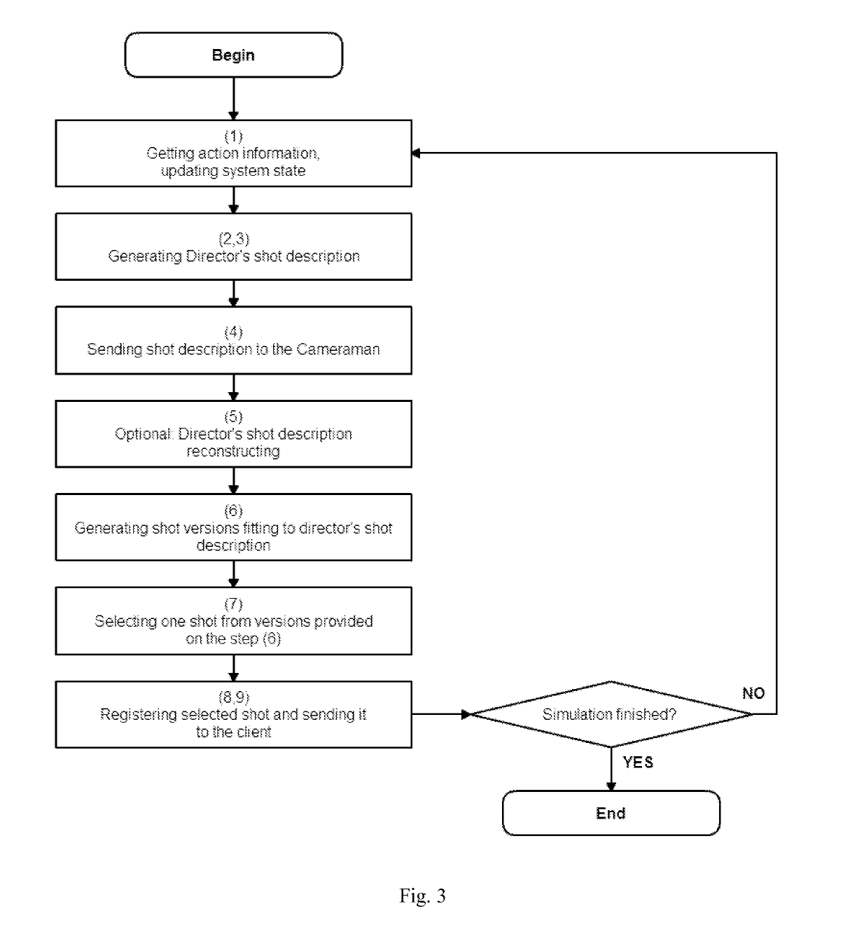

Below is an exemplary operation algorithm of the method shown with reference to FIGS. 2 and 3.

1. Information regarding the action is received from an application and is reconverted into a syntactic base for a cinematographic phrase. The system is adapted to operate both in the action start signal standby mode (I) and the packetized sequence of actions processing mode (the entire packet is received at a time from the client) (II). At this point, the system status may be updated.

2. The director's description of a shot to be filmed is calculated. The type of action (predicate), protagonist (subject), secondary characters (objects) are included.

3. The already filled in part of the editorial script is also included. For example, the director's shot description is affected by the following: whether shooting of a new action starts or shooting of an old action continues; in some cases, there is dependence between the parameters of a previous shot and the allowable parameters of a next shot; the current step of action if it continues, and the like. An element is registered in the editorial script at step 8.

4. The description is provided to the camera operator input.

5. If necessary, the camera operator reconstructs the director's shot descriptions relying on the author's shots (if a given shots remain unchanged during the script, these may be calculated only at the system initialization step).

6. A set of shot variants is generated according to the director's shot description.

7. The best shot is chosen from the set of shot variants. The best shot is considered to be the one closest to the director's shot description while meeting some requirements external with respect to the same (for example, the visible area percentage of the object being shot; observance of the 180-degree rule; absence of foreign objects in the focus of attention of the shot ((contrasting objects and/or objects occupying a considerably large area of the shot's central part with respect to the objects being filmed)). In a particular embodiment, either step 6 or step 7 or both steps 6 and 7 are performed iteratively until a certain condition is met.

8. The shot is returned to the director to perform the required actions for registration of the same. These actions include updating the shot details in the editorial script, if the director's description thereof has been added or otherwise adding the entire information.

9. The shot is provided to the client program: either at once (for example, in the mode B (B)) or as part of the entire sequence of shots received on the client's request (for example, in the modes (A) and (C)).

Examples of the device implementing the invention will be given below by way of general explanation.

The invention may be implemented in any type of a computer (including but not limited to personal computer, smartphones, tablets, game consoles, and the like).

In an embodiment of the invention, a computer device has a processor functionally related to any type of a random-access memory. The device may be coupled to a display for presentation of the video content. A mouse and a keyboard may be used for inputting the information. Accordingly, the invention may be implemented using the client programs and computer instructions executable by the processor and performing the functions according to the aspects of the invention.

The above device is just an example of the devices implementing the invention.

The description of the virtual space and actions is loaded in the RAM by means of a keyboard and a mouse and is read out from the RAM by the client program. This data is converted by the client program and stored in the RAM from where the processor will read out the same. In operation, the processor executes the computer instructions according to the aspects of the invention and writes the operation results into the RAM. The client program reads out the operation results from the RAM and applies the same to the virtual space to form the image for outputting to the display.

Let us assume that the client program reproduces the following scene composed of the virtual space objects and a combination of actions to be implemented. An exemplary data flow between the input device and the output device is provided below.

Objects

There is a room wherein a character stays. There is a window in the room.

Actions

The character says, ‘That's all, good-bye to everybody’, looks sadly at the floor, then walks to the window, opens it and jumps out.

The system receives the following sequence of actions:

1. Action type: to speak.

Protagonist: character.

Operand (object, “above what”): none.

Operand (object, “with the aid of what”): none.

Other parameters: . . .

2. Action type: to look.

Protagonist: character.

Operand (object, “above what”): floor.

Operand (object, “with the aid of what”): none.

Other parameters: . . .

3. Action type: to walk.

Protagonist: character.

Operand (object, “above what”): window.

Operand (object, “with the aid of what”): none.

Other parameters: . . .

4. Action type: to open.

Protagonist: character.

Operand (object, “above what”): window.

Operand (object, “with the aid of what”): none.

Other parameters: . . .

5. Action type: to jump out.

Protagonist: character.

Operand (object, “above what”): window.

Operand (object, “with the aid of what”): none.

Other parameters: . . .

As a result, N sets of camera parameters will be received from the system. The value of N is dependent on the duration of action and other factors. Let us assume that the following shots will be required to film the actions:

1. Action “to speak”: 1 shot;

2. Action “to look”, 1 shot;

3. Action “to walk”, 2 shots;

4. Action “to open”, 1 shot;

5. Action “to jump out”, 1 shot.

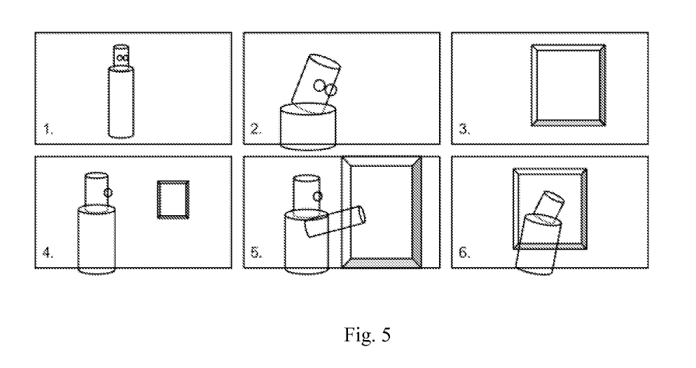

By applying the obtained parameters to the camera at respective instants in time, the client will obtain the shot as shown in FIG. 5 (in this example, the camera position and other camera parameters remain unchanged in the intervals between these instants while the action proceeds in due course).

Editing modes. The director may operate in two modes:

linear editing mode with a known sequence of script events;

linear editing mode using information regarding only the past and current script events;

system operation results may be used for nonlinear editing.

Shot sizes and vertical composition

Various cinematographic schools use different systems of shot sizes. They have much in common but also have some differences. For example:

Kuleshov shot sizes

detail: part of face;

close-up: head;

1^{st} medium shot: waist-high;

2^{nd} medium shot: knee-high;

long shot: full-length;

very long shot: small part of shot, no details are visible.

Alternative system of shot sizes:

close-ups: part of face, face, breast (nipples);

medium shoots: waistline, hips (Hollywood), knees;

long shots: full-length, very long shot.

Systems of shot sizes and algorithms according to the invention.

The system discriminates 9 types of shot sizes. These are implemented based on the known characters' proportions described in the respective tables for each character.
If such table is not associated with a character, a set of standard proportions is provided.

The system automatically calculates the air, shot sizes and based thereon constructs a vertical composition.

Therefore, the shot size for the director's shot description is defined by types, such as “Long1”, “Medium2”, and the like rather than by numbers.

Horizontal composition.

Two characters or a group are on-screen. Adjustment is performed relative to the shot center. The scale is defined by the selected shot size of the selected character.

One character is on-screen. The other participants in the action (if any) are off-screen. The horizontal composition is implemented, horizontal air is calculated.

Movement. Walking in and out of shot. Everything is also OK.

Vertical perspective

The vertical perspective for the director's shot description is defined by types, such as “Regular”, “Lower”, “Upper” rather than by numbers.

The regular perspective is mainly used.

In particular cases, if necessary, upper and lower perspectives are used. Let us input the “domination” or “strength” parameter for a character in the context of action. If this parameter has a neutral value, the regular perspective will be used. If its value is low, the upper perspective will be used. Otherwise, the lower perspective will be used to show that the character dominates.

Horizontal perspective and line of action.

The shots are classified by the following types in terms of the horizontal perspective:

frontal;

30° internal;

60° internal;

profile;

60° external;

30° external;

rear.

They are constructed relative to the action line and the action protagonist (protagonists).

These types divide the radial space (more specifically, half of the circle divided by the action line and relative thereto) around the objects being filmed into sectors. Precisely this system is very convenient for applying the 30-degree rule (http://en.wikipedia.org/wiki/30-degree_rule), the 180-degree rule and many other rules of the cinematographic language.

Optimum shot selection according to the director's instructions

CameraOperator is a class returning the calculated camera (position, perspective . . . ) depending on the particular conditions and limitations imposed on the shot by the director.

The main problem faced in attempt to implement the caller's requirements is the visibility problem.

If the key objects of the shot are obstructed by foreign objects, the simplest solution to the problem might be to render the same semitransparent such as in the videogames. However, this approach is inacceptable for the purposes of the invention. Therefore, the camera operator tries to find a new perspective according to the following two algorithms.

Algorithm 1 for generation of cameras for the desired shot.

In this case, it is very likely that the original director's conception will be disturbed because the optimum shot will be beyond the range of desired values.

Potential perspectives are arranged in a spiral relative to the desired shooting direction. This spiral lies on the surface of a sphere circumscribed around the shooting center (the sphere radius is dependent on the selected shot size). The perspective varies by default with a 10-degree increment with the spiral radius being defined by a limitation on the maximum deviation from the desired perspective. This value is 30 degrees by default. The perspectives not falling under the limitations on the vertical deviation are also ignored. The vertical range for the regular perspective is from 0 to 20 degrees.

This is the first series of candidates. The second series is formed using the cameras arranged in a horizontal plane around the whole circle. First, a left-hand camera with a 30-degree increment is added as a candidate and then a right-hand camera. Thereafter, a still further left-hand camera and a still further right-hand camera are added. And so on until a horizontal perspective is reached opposite to the desired one.

It should be noted that all candidates are added in the order of priority. In other words, the sequential number comprises an error function. A first candidate meeting the minimum requirements is chosen from this list.

Both series of candidates lie on the surface of the same sphere.

Algorithm 2 for generation of cameras for the desired shot.

It is a particular case of algorithm 1. It calculates only the shots within the range of values allowable by the director.

Potential perspectives are arranged in a spiral relative to the desired shooting direction. This spiral lies on the surface of a sphere circumscribed around the shooting center (the sphere radius is uniquely dependent on the selected shot size). The perspective varies by default with a 5-degree increment with the spiral radius being defined by a limitation on the maximum deviation from the desired perspective. This value is 15 degrees by default. The perspectives not falling under the limitations on the vertical deviation are also ignored. The vertical range for the regular perspective is from 0 to 20 degrees.

The camera operator also checks whether this camera may be placed in the real world. For example, if a camera is arranged too close to an object, crosses the same or is inside the same, it is impossible place such a camera.

In addition, the optimum shot selection algorithms implement the following functions:

use of the specified camera array as prompts for automatic algorithms. This functionality may be also used for simulation of the basic elements of the author's style;

use of the specified camera array to supplement the automatically formed ones. The one best fitting for shooting at the moment will be chosen from the aggregate array.

Cinematographic narration structure.

By way of explanation of an exemplary use of the invention, the proposed system is built in a text visualization system described in international application PCT/RU2011/000666 filed on 31 Aug. 2011, the entire contents of which are hereby incorporated by reference, for enhancement of its functionality with the above functions.

The text visualization system converts a script written in a natural language into 3D animated videos. An intermediate stage of such conversion comprises selecting protagonists and actions from the script. As a result, a narration frame is obtained defining goals for the characters and forming a basis of defining a shooting plan for the proposed solution.

Having processed the natural language, the main part of the text visualization system operates with a simplified language model. This is a sequence of one-type action phrases in the form of an aggregate (who, what was done, above what, with the aid of what, additional modifiers and parameters).

They are further converted into goals by the behavior simulation subsystems and performed.

The proposed system converts this aggregate back into a “frame” of a natural language sentence, that is, into a syntax in the form of an aggregate of the sentence parts (subject, predicate, objects, . . . ). In a particular case, a more fractional aggregate is available which is obtained already in the process of behavior performance.

Each such structure fits well to the editing language and may be relatively readily transformed into a cinematographic phrase (finished sequence of shots presenting an action).

Indeed, let us remember that a subject answers to the questions “Who?”, “What?”; a predicate answers to the questions “What is he/she doing?”, “What is going on with him/her?”, and the object answers to the questions “By means of what?”, “With the aid of what?” “Above whom?”, etc.

This is a direct presentation of the classic elementary editing principles. For example, a shot presenting an object with a certain size gives an answer to a well-defined question.

As used herein, the terms “component” and “system” refer to a computer entity comprising either hardware or a combination of hardware and software or software or executable software. For example, a component may comprise without limitation a process for running on a processor, a processor, a hard disk drive, multiple drives (of an optical and/or magnetic medium), an object, an executable module, an execution thread, a program and/or a computer. By way of illustration, a component may comprise both an application for running on a server and a server itself. One or more components may be arranged within an execution process and/or thread and a component may be arranged within a single computer and/or distributed among two or more computers.

Although the above description relates in general to computer instructions executable on one or more computers, it will be obvious to those skilled in the art that a new embodiment may be also implemented together with other software modules and/or as a combination of hardware and software.

In a general case, the software modules comprise procedures, programs, components, data structures, etc. for performing certain tasks or implementing certain abstract data types. In addition, it will be obvious to those skilled in the art that the methods according to the invention may be practiced by means of other computer system configurations including but not limited to uniprocessor or multiprocessor computer systems, minicomputers, general-purpose computers as well as personal computers, handheld computing devices, microprocessor-based or programmable consumer electronic devices and the like, each of which may be connected in operation to one or more respective devices.

The illustrated aspects may be also applied in practice in the distributed computing environments wherein the tasks are performed by remote processing devices interconnected via a data communications network. In a distributed computing environment, the software modules may be arranged both in local and remote storage devices.

A computer in general comprises various computer-readable media. The computer-readable media may comprise any available media which the computer may access and include volatile and nonvolatile, removable and stationary media. By way of example and without limitation, the computer-readable media may comprise computer storage media and communication media. The computer storage media include volatile and nonvolatile, removable and stationary media implemented using any data store method or technology, for example, computer-readable instructions, data structures, software modules or other data. The computer storage media include without limitation RAM, ROM, EEPROM, flash-memory or another memory technology, CD-ROM, digital versatile disks (DVD) or other optical disks, magnetic cassettes, magnetic tape, magnetic disk storage or other magnetic storage device or any other medium suitable for storing useful information and accessible to the computer.

The computer has a processor, a system memory and a system bus. The system bus enable an interface for the system components including but not limited to the system memory-to-processor interface. The processor may be any of various commercially available processors.

Double microprocessors and other multiprocessor architectures may be also used as processors.

The system bus may be any of a number of bus structure types and may be further connected to a memory bus (with or without a memory controller), a peripheral bus and a local bus using any of a variety of commercially available bus architectures. The system memory includes a read-only memory (ROM) and a random-access memory (RAM). A basic input/output system (BIOS) is stored in a nonvolatile memory, for example, ROM, EAROM, EEPROM, wherein the BIOS comprised the basic procedures which assist in the data transfer between the computer elements, for example when started. The RAM may also include a high-speed RAM, for example a static RAM for data caching.

The computer further has an internal hard disk drive (HDD) (for example, EIDE, SATA) also adaptable to external use in a suitable hosing, a magnetic floppy disk drive (FDD), (for example, for reading from or writing to a removable diskette) and an optical disk drive (for example, miltiread CD-ROM or for reading from or writing to other high-capacity optical media, for example, DVD). The hard disk drive, magnetic disk drive and optical disk drive may be all connected to the system bus via a hard disk drive interface, a magnetic disk drive interface and an optical disk drive interface, respectively. The external drive interface includes at least one or both of the universal serial bus (USB) and IEEE 1394.

The drives and the respective computer storage media enable a nonvolatile storage for data, data structures, computer instructions, etc. The drives and media enable storage of any computer data in any suitable digital format. Although the above description of the machine-readable media relates to HDD, removable magnetic diskette and removable optical media, for example, CD or DVD, it will be obvious to those skilled in the art that other types of machine-readable media, for example, zip disks, magnetic cassettes, flash memory cards, cartridges, etc. may be also used in the illustrative operating environment and in addition, any such media may comprise computer instructions for carrying out the novel methods of the disclosed architecture.

The drives and RAM may store a number of software modules including the operating system, one or more application programs, other software modules and program data. The operating system, applications, modules and/or data may be in part or in full cashed in the RAM. It is also obvious that the disclosed architecture may be implemented with various commercially available operating systems or combinations of operating systems.

The user may input the instructions and information into the computer via one or more wired/wireless input devices, for example, a keyboard and a pointing device, a mouse. The input/output devices may include a microphone/speakers and another device, for example, an IR control panel, a joystick, a game console, a stylus, a touch screen, and the like. These and other input devices are often connected to the processor via an input interface connected to the system bus but may be connected via other interfaces, for example, a parallel port, IEEE 1394 serial port, a game port, a USB port, an IR interface, etc.

A monitor or another type of display device may also be connected to the system bus via an interface, for example, a video adapter. In addition to the monitor, the computer generally included other peripheral output devices, for example, speakers, printers, etc.

The computer may operate in the network environment using logical connections via wired and/or wireless communication with one or more remote computers, for example remote computer(s). The remote computer(s) may comprise a work station, a server computer, a router, a personal computer, a portable computer, a microprocessor-based entertainment device, a peer device or another common network node and generally includes many or all of the elements described above with reference to the computer although for the sake of brevity, only the storage device is shown. The described logical connections include wired/wireless connection to a local-area network (LAN) and/or to more large-scale networks, for example, a wide-area network (WAN). Such LAN and WAN network environments are usually used in offices and companies to enable enterprise-wide computer networks, for example, intranets that may be connected to the wide-area networks, for example, the Internet.

When used in the LAN network environment, the computer is connected to the local-area network via a wired and/or wireless communication network interface or adapter. The adapter may enable wired or wireless connection to the LAN that may include a wireless access point for communication with a wireless adapter.

When used in the WAN network environment, the computer may include a modem or may be connected to a communication server in the WAN or may have another facility for establishing communication in the WAN, for example, in the Internet. The modem which may be either an internal or external, wired and/or wireless device is connected to the system bus via the serial port interface. In a network environment, the software modules or some of the software modules described with reference to the computer may be stored in a remote storage device. The described network connections are illustrative and other facilities may be used for establishing lines of communication between computers.

The computer is able to communicate with any wireless devices in operative wireless communication, for example, with a printer, a scanner, a desktop and/or portable computer, a tablet, a communication satellite. This includes at least WiFi and Bluetooth™ wireless technologies. Accordingly, the communication may be a predefined structure such as in a traditional network or just a dedicated communication channel between at least two devices.

Examples of the disclosed architecture have been provided above. It is certainly impossible to describe all conceivable combinations of components or methods however it will be obvious to a person skilled in the art that multiple additional combinations and rearrangements are possible. Accordingly, the novel architecture is intended to encompass all such changes, modifications and variation not departing from the scope and spirit of the appended claims. In addition, inasmuch as the term “comprise” is used in the detailed description and the claims, such term is intended to be inclusive similar to the term “including” since “including” is understood as a transition word when used in the claims.

1. A computer implemented method for automatically controlling a video shooting process, said method comprising the steps of:
obtaining information regarding the action in the scene;
calculating a director's description of a shot to be filmed;
providing the shot description to a camera operator;
generating a set of shot variants is generated according to the director's shot description;
obtaining camera parameters for shooting each of the set of shot variants;
choosing the best shot from set of shot variants;
providing the shot back to the director who finally registers the same in the editorial script;
filming the best shot with the respective camera;
obtaining subsequent shots of the scene actions by repeating previous method steps;
generating a sequence of shots according to the editorial script;
providing the sequence of shots to a client program.

2. The method according to claim 1, wherein the information regarding the action in the scene is obtained responsive to an action start signal.

3. The method according to claim 1, wherein the information regarding the scene action is obtained in the form of a packetized sequence of actions, wherein the whole packet is obtained at a time.

4. The method according to claim 1, wherein the director's shot description includes the information regarding the type of action (predicate), protagonist (subject), secondary characters (objects).

5. The method according to claim 1, wherein in the director's shot description includes the already filled in part of the editorial script.

6. The method according to claim 1, further comprising the step of reconstructing the director's shot descriptions based on the author's shots, wherein said author's shots are the shots obtained using the user-preinstalled cameras.

7. The method according to claim 1, wherein, the best shot is considered to be the one closest to the director's shot description while meeting the requirements external with respect to the same.

8. The method according to claim 7, wherein the requirements is the visible area percentage of the object being filmed.

9. The method according to claim 7, wherein the requirement is the observance of the 180-degree rule.

10. The method according to claim 7, wherein the requirement is the absence of foreign objects in the focuses of attention of the shot.

11. The method according to claim 10, wherein the foreign objects are contrasting objects and/or objects occupying a considerably large area of the shot's central part with respect to the objects being filmed.

12. The method according to claim 7, wherein the set of shot variants according to the director's shot description is generated and the best shot is chosen iteratively until the requirements are met.

13. The method according to claim 1, wherein each shot is provided to the client program immediately upon receipt.

14. The method according to claim 1, wherein a sequence of shots is provided to the client program on the client's request.

15. The method according to claim 1, further comprising the step of outputting the shot image to a display.

16. The method according to claim 1, further comprising setting an array of cameras for use as prompts.

17. The method according to claim 1, further comprising setting an array of author's cameras is set to supplement the automatically formed ones.

18. The method according to claim 1, further comprising the step of linear editing with a known sequence of script events.

19. The method according to claim 1, further comprising the step of linear editing using information regarding only the past and current script events.

20. The method according to claim 1, further comprising the step of filling in the editorial script beforehand in for a number of shots in advance when starting a new action.

21. A machine readable medium comprising computer executable instructions which when loaded to a computer cause the computer to perform the steps of a method for automatically controlling a video shooting process, said method comprising the steps of:
obtaining information regarding the action in the scene;
calculating a director's description of a shot to be filmed;
providing the shot description to a camera operator;
generating a set of shot variants is generated according to the director's shot description;
obtaining camera parameters for shooting each of the set of shot variants;
choosing the best shot from set of shot variants;
providing the shot back to the director who finally registers the same in the editorial script;
filming the best shot with the respective camera;
obtaining subsequent shots of the scene actions by repeating previous method steps;
generating a sequence of shots according to the editorial script;
providing the sequence of shots to a client program.
